(19) United States
(12) Patent Application Publication
(10) Pub. No.: US 2026/0254297 A1
(43) Pub. Date: Aug. 27, 2026

(54) ELECTROMECHANICAL ACTUATOR COMPRISING A COMPACT AND LOW-NOISE SYNCHRONOUS RELUCTANCE MOTOR

(71) Applicant: SOMFY ACTIVITES SA, CLUSES (FR)

(72) Inventors: Thierry TOLLANCE, CLUSES (FR); Ronan GEORGEAULT, CLUSES (FR); Frédéric GILLON, VILLENEUVE D'ASCQ (FR); Abdelmounaïm TOUNZI, VILLENEUVE D'ASCQ (FR); Michel HECQUET, VILLENEUVE D'ASCQ (FR)

(21) Appl. No.: 18/877,350

(22) PCT Filed: Jun. 16, 2023
(86) PCT No.: PCT/FR2023/050874

§ 371 Date: Dec. 20, 2024

(30) Foreign Application Priority Data
Jun. 24, 2022 (FR) FR2206349

(51) Int. Cl. H02K 1/24; H02K 1/16; H02K 19/10

(52) U.S. Cl. CPC H02K 1/246; H02K 1/165; H02K 19/103; H02K 2201/03; H02K 2205/12; H02K 2207/03

(57) ABSTRACT

An electromechanical actuator for actuating a blackout device such as a roller shutter or a blind, having a casing, a head intended to be fastened to a fixed structure, a synchronous type motor, a speed reducer and a motor control unit, the motor, the speed reducer and the control unit being inserted into the casing of the electromechanical actuator. The motor further includes a cylinder-shaped rotor, a cylinder-shaped stator, disposed coaxially about the rotor and including teeth extending radially towards the rotor, and a coil forming a winding about each of the teeth of the stator. The stator has an external diameter smaller than 55 mm. The rotor is formed by an assembly of sheet metal plates and has recesses about a longitudinal axis of the rotor, wherein the rotor includes an arrangement of the recesses forming four poles, the rotor with two or three recesses per pole.

### CROSS-REFERENCE TO RELATED APPLICATIONS

This application is a 35 U.S.C. § 371 National Stage patent application of PCT/FR2023/050874, filed on 16 Jun. 2023, which claims the benefit of French patent application 22/06349, filed 24 Jun. 2022, the disclosures of which are incorporated herein by reference in their entirety.

### TECHNICAL FIELD

The present disclosure relates to the field of electric motors and more particularly to synchronous “brushless” electric motors in the power ranges from a few tens of watts to a few hundreds of watts. Such motors are for example implemented in electromechanical actuators in the field of home automation installations. These actuators are used in particular to rotate a winding shaft or tube to drive a roller shutter or a blind to blackout a window or a door of a building.

### BACKGROUND

A synchronous “brushless” electric motor conventionally comprises a rotor and a stator including several windings. In applications where the motor is fitted to an electromechanical actuator driving in rotation a winding tube, it is desirable, for reasons of space, to house the actuator in the winding tube, which imposes heavy constraints on the actuator in terms of volume and temperature. Indeed, the motor itself is encapsulated in a casing, usually made of metal, of the actuator. The diameter of the motor is therefore limited to a few centimeters. Under these conditions, it is difficult to ventilate the motor. On the other hand, the actuator can also be subjected to high temperatures when it is mounted in the winding tube of a roller shutter or a blind mounted on the facade of a building. The length of the motor is also reduced as much as possible to allow an actuator length to be adapted to the widest range of applications.

In the field of synchronous “brushless” electric motors, the synchro-reluctance motor is increasingly popular, due to its performance, in particular in terms of power-weight ratio and noise, compared to other motors such as cage induction motors. The synchro-reluctance motor can be supplied with a sinusoidal or trapezoidal signal. It also most often comprises Hall effect sensors for detecting the position of the rotor relative to the stator.

A main advantage of synchro-reluctance motors is that they can operate without magnets. This feature makes it possible to limit production costs and overcome any difficulties in sourcing magnets. However, the main difficulty lies then in particular in the construction of the rotor, whose diameter is particularly small.

However, by reducing the size of the motors, resonance phenomena appear between the electromagnetic forces occurring within the motor and the mechanical elements of the latter. These resonance phenomena correspond to a noise spectrum that can comprise peaks in the audible frequency range that prove to be annoying to humans.

It is therefore desirable to propose improvements to synchro-reluctance type motors, in order to adapt their manufacture, without penalizing their performance in terms of generated torque, power consumption, released heat and generated noise.

### SUMMARY

Embodiments relate to an electromechanical actuator for actuating a blackout device such as a roller shutter or a blind, comprising a casing, a head intended to be fastened to a fixed structure, a permanent magnet synchronous type motor, a speed reducer and a motor control unit, the motor, the speed reducer and the control unit being inserted into the casing of the electromechanical actuator, the motor comprising: a cylinder-shaped rotor, a cylinder-shaped stator, disposed coaxially about the rotor and including a plurality of teeth extending radially towards the rotor, and a coil forming a winding about each of the teeth of the stator, characterized in that: the stator has an external diameter smaller than 55 mm, the rotor is formed by an assembly of sheet metal plates, the rotor comprises recesses about a longitudinal axis of the rotor, the rotor comprising an arrangement of the recesses forming four poles, the rotor comprising two or three recesses per pole.

The motor actuator thus defined is particularly compact and inexpensive, while providing performance adapted in particular to roller shutter control applications for low torques. In particular, this rotor manufacturing technique proves to be particularly inexpensive and fast. In addition, it makes it possible to easily modify the length of the motor according to the desired performance, in particular the torque to be provided by the motor. The impact of the number of recesses on the torque value that the motor can provide must be counterbalanced by the technical feasibility of creating these housings in the space of a rotor section and the mechanical strength of the rotor. Thus, an optimal number of recesses per pole is equal to two or three.

According to one embodiment, the stator comprises six teeth.

The motor diameter can be reduced by choosing a reduced number of “magnetic” poles and windings, without affecting the motor's performance in terms of torque, power consumption and heat emission. The 6 windings/4 “magnetic” poles pair has interesting performance in the field of application of blinds and roller shutters, with a particularly compact stator.

According to one embodiment, the rotor comprises a first rotor groove extending on a cylindrical face of the rotor facing each of the poles, the first rotor groove being centered on a line located outside a first median plane of the pole, passing through the longitudinal axis of the rotor.

By modifying the air gap permeance of the motor, this first groove makes it possible to attenuate an annoying peak in the noise spectrum emitted by the motor, without significantly affecting the motor's performance.

According to one embodiment, the rotor comprises a second rotor groove extending on a cylindrical face of the rotor facing each of the poles. This second groove also modifies the air gap permeance of the motor and therefore can also modify the noise spectrum.

According to one embodiment, the first and second rotor grooves are disposed symmetrically with respect to the first plane.

This second groove makes it possible to symmetrize the behavior of the motor in both directions of rotation and thus to obtain an identical result regardless of the direction of rotation of the motor. Thanks to this arrangement, the symmetry of behavior of the motor in terms of noise and performance can be adapted to the operation of the actuator for winding or unwinding a mobile screen, regardless of the mounting direction of the actuator.

According to one embodiment, the first or second rotor groove or each of the first and second rotor grooves has at least one of the following characteristics:
an angular position about the longitudinal axis of the rotor with respect to the first plane of between 0 and 35°,
a semi-circular section, and
a semi-circular section having a radius of between 0.4 and 1.8 mm.

According to one embodiment, each tooth of the stator comprises a stator groove formed in a free end of the tooth.

This arrangement in combination or not with one or two grooves on the rotor also makes it possible to reduce the audible noise peak emitted by the motor, without significantly affecting the motor's performance.

According to one embodiment, the stator groove formed in each tooth of the stator has at least one of the following characteristics:
it is centered on a second median plane of the tooth passing through a longitudinal axis of the stator,
It has a width of 0.2 to 3 mm, and
It has a depth of 0.2 to 6 mm.

The centered position of the grooves in the teeth of the stator makes it possible to further reduce the audible noise peak emitted by the motor.

According to one embodiment, the actuator is powered by the AC mains network.

According to one embodiment, the control unit applies a sinusoidal or trapezoidal control to the motor.

The motor's performance can be achieved by either of these control types.

According to one embodiment, the stator is formed by an assembly of sheet metal plates.

This manufacturing technique proves to be particularly fast and inexpensive. In addition, it makes it possible to easily modify the length of the stator according to the desired performance, in particular the torque to be provided by the motor. In addition, this technique makes it possible to simplify the production of the grooves which can be obtained by forming notches in the sheet metal plates.

According to one embodiment, the motor has a power less than or equal to 300 W.

The aforementioned characteristics of the motor are particularly suitable for motors in this power range.

According to one embodiment, the thickness of the sheets forming the rotor is between 0.3 and 0.7 mm, preferably 0.5 mm.

Embodiments may also relate to a blackout device of the roller shutter or blind type, comprising an actuator as previously defined.

### BRIEF DESCRIPTION OF THE FIGURES

The present disclosure will be better understood from the following description with reference to the appended figures, in which identical reference signs correspond to structurally and/or functionally identical or similar elements.

FIG. 1 is a schematic perspective and longitudinal sectional view of a synchro-reluctance motor, according to one embodiment,

FIG. 2 is a schematic cross-sectional view of the synchro-reluctance motor, according to one embodiment,

FIG. 3 is a schematic side view of a rotor of the synchro-reluctance motor, according to one embodiment,

FIG. 4 is a schematic cross-sectional view of the rotor, according to one embodiment,

FIG. 5 is a schematic top view of a rotor plate, according to one embodiment,

FIG. 6 is a schematic top view of a rotor plate, according to another embodiment,

FIG. 7 is a schematic top view of a rotor plate, according to another embodiment,

FIGS. 8, 8A are schematic cross-sectional views of a synchro-reluctance motor, according to one embodiment, FIG. 8A being an enlarged view of a portion of FIG. 8,

FIG. 9 is a schematic cross-sectional view of the rotor, according to another embodiment,

FIG. 10 is a schematic cross-sectional view of the rotor, according to another embodiment,

FIG. 11 is a schematic cross-sectional view of an actuator, according to one embodiment, and

FIG. 12 is a schematic perspective view of a home automation installation, according to one embodiment.

### DETAILED DESCRIPTION OF THE FIGURES

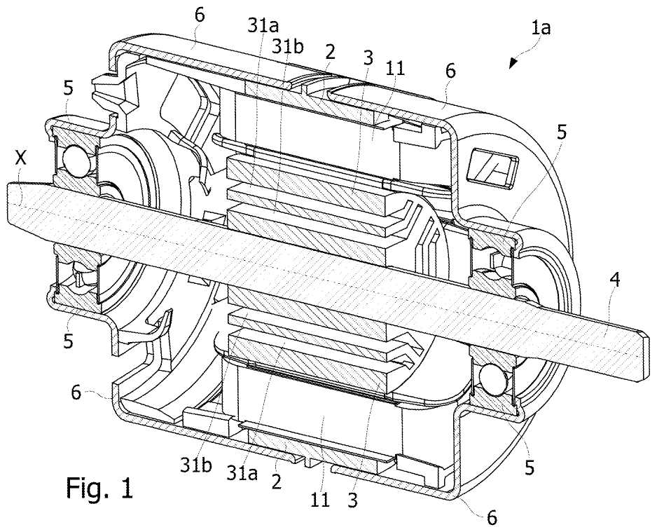

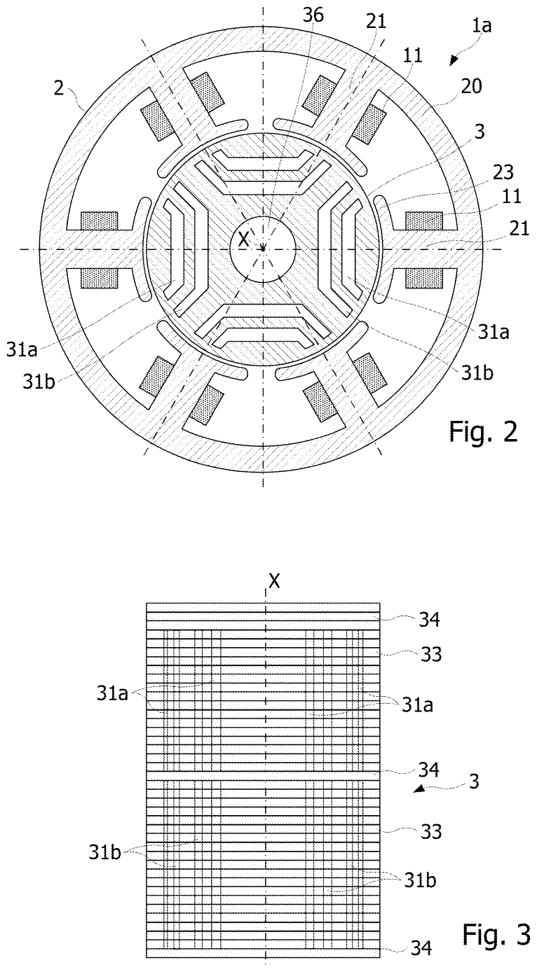

FIGS. 1 and 2 represent a synchro-reluctance type motor 1a, according to one embodiment. The motor 1a comprises a stator 2, a rotor 3 and a shaft 4 secured to the rotor, these three elements being coaxial and housed in a casing 6. The casing 6 is secured to the stator 2 and linked to the shaft 4 through bearings 5, for example of the ball bearing type.

In FIG. 2, the stator 2 has a hollow cylindrical shape 20 and comprises teeth 21 extending radially towards the inside of the cylindrical portion 20. The teeth are designed to each receive a winding 11. The teeth 21 may each have a free end extended by a tile-shaped plate 23.

According to one embodiment, the rotor 3 is of the transverse lamination type, otherwise called flux barrier type, without magnets. Thus, the rotor 3 has a cylinder-shaped outer contour, inside which recesses 31a, 31b forming flux barriers are formed. The recesses 31a, 31b are distributed about a longitudinal axis X of the rotor and grouped in pairs of recesses centered on a longitudinal plane of the rotor 3. Each pair of recesses 31a, 31b, comprises a recess 31a further from the longitudinal axis X of the rotor 3 and a recess closer to this axis. The rotor also has a central bore 36 in which the shaft 4 driven in rotation by the rotation of the rotor 3 is fastened. The symmetrical geometric arrangement of the different recesses, and therefore of the different flux barriers about the longitudinal axis X of the rotor, creates rotor poles, for example four poles. The curved plates 23 at the end of the teeth 21 of the stator match the cylindrical shape of the rotor 3 while maintaining a substantially constant air gap in the facing region between each plate 23 and the outer contour of the rotor 3.

In the example of FIG. 2, the stator 2 comprises six teeth 21 and the rotor 3 comprises four poles formed by the arrangement of the recesses.

The axial length of the rotor 3 may be greater than that of the stator so as to be able to capture the magnetic flux created by the arrangement of the rotor recesses by Hall effect sensors which give the position of the rotor required for motor 1a drive.

The stator 2 has an external diameter smaller than 55 mm, for example between 35 and 55 mm. It may have a length of between 14 and 20 mm. The rotor 3 may have a diameter of between 18 and 25 mm and a length of between 18 and 25 mm. The air gap may be between 0.2 and 0.6 mm, for example equal to 0.3 mm.

The coil forming the windings 11 about the teeth 21 may be single or double-layer, of the dental or concentric and distributed type. The coil can be made with copper wire of 0.12 to 0.2 mm to form between 700 and 1000 turns about the teeth 21.

The stator 2 and the rotor 3 can be made by a stack of a plurality of plates cut from a sheet metal with a small thickness, for example between 0.3 and 0.7 mm. The plates can be assembled by staples, in particular so as to ensure their alignment. Thus, FIG. 3 represents the rotor 3 formed by a stack of two types of plates 33, 34, the plates 34 forming magnetic shunts. In the example of FIG. 3, the rotor 3 is formed by 40 plates 33, 34, including three plates 34, then a group of sixteen plates 33 and a group of nineteen plates 33, separated by a plate 34, and finally a plate 34.

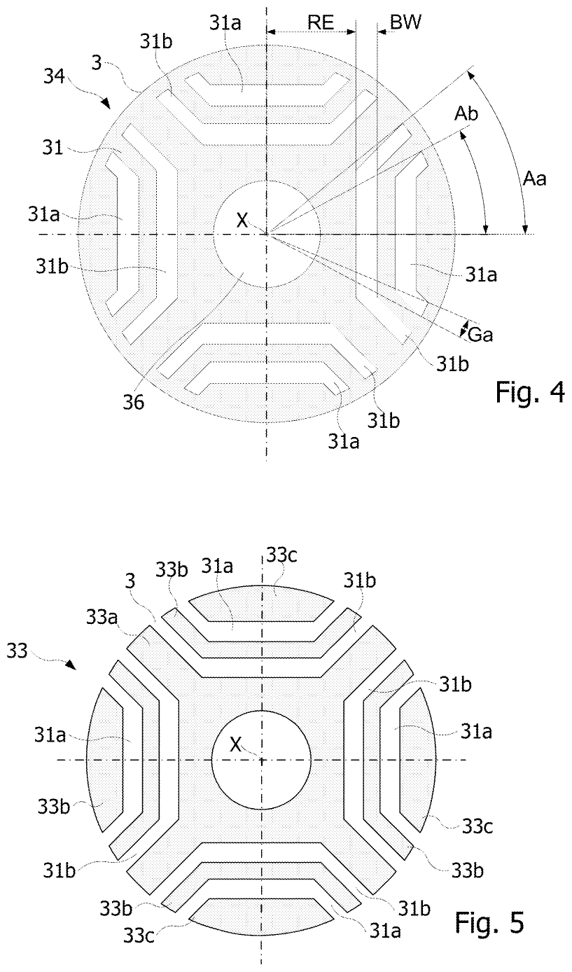

FIGS. 2 and 4 show the shape of the plates 34 for a rotor with two recesses forming the flux barriers per pole. The recesses 31a, 31b forming the flux barriers are substantially an assembly of straight segments. For example, as shown in FIGS. 4 and 5, the section of a recess can take a rectangular shape at the median level of the pole, extended on either side of the short side by substantially trapezoidal extensions.

Straight segment recesses can be defined by the following parameters:
the radius RE of a circle centered on the longitudinal axis X of the rotor 3 beyond which the recesses 31a, 31b are formed,
the width BW of a central segment of the recesses 31a, 31b,
the half-angles Aa, Ab about the longitudinal axis X of the rotor 3, of extension of each of the recesses 31a, 31b, and
the opening angle Ga about the longitudinal axis X of the rotor of each of the recesses 31a, 31b on the edge of the rotor.

According to an alternative embodiment represented in FIG. 9, the recesses 31a′, 31b′ forming the flux barriers have a section substantially in the form of a ring portion and can be defined by the following parameters:
the radius Rba of the bottom of the first recess 31a, closest to the edge of the rotor,
The radius Rbb of the bottom of the second closest recess 31b,
The median radius Rfer between the first and second recesses 31a, 31b,
The width LB of a recess, this width may be common for all the recesses.

Other flux barrier geometries may be envisaged without departing from the scope of the present disclosure.

According to the embodiment with two recesses per pole, the recesses 31a, 31b extend in pairs along a radius of the rotor 3 and are spaced from each other and from the longitudinal axis X of the rotor.

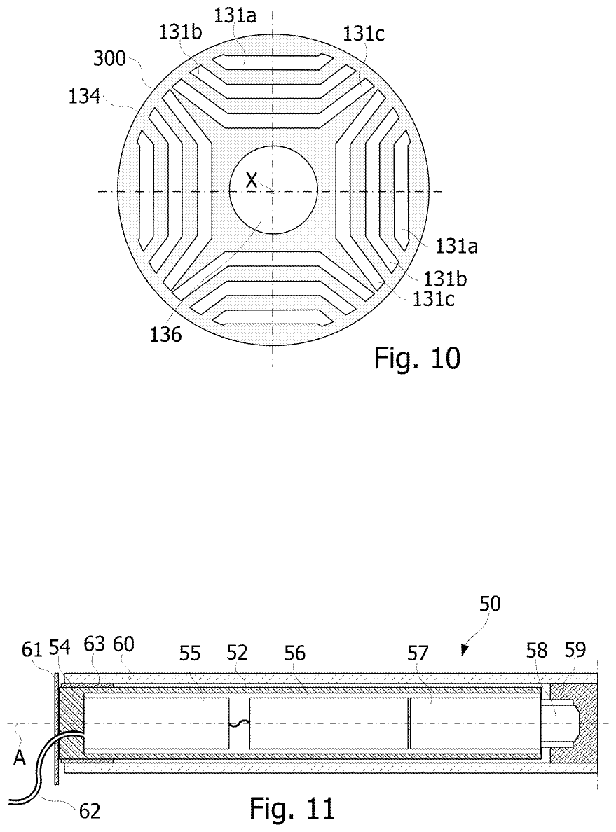

According to an alternative embodiment represented in FIG. 10, a rotor 300 comprises three recesses 131a, 131b, 131c per pole, a third recess 131c extends transversely to a radius of the rotor 3 and is spaced from the recesses 131a, 131b, 131c in a radial direction of the rotor 300.

FIG. 5 shows the shape of the plates 33. The plates 33 differ from the plates 34 in that the recesses 31a, 31b are through recesses, that is to say extend to the edge of the plates forming the cylindrical face of the rotor, dividing each plate 33 into a central part 33a, intermediate parts 33b and peripheral parts 33c. The parts 33b and 33c delimit with the central part 33a, the contour of the recesses 31a and 31b. In the assembled construction of the rotor, the recesses 31a, 31b form freely through spaces open to the cylindrical outer wall of the rotor 3. In the arrangement of the plates 33, 34 represented in FIG. 3, the recesses 31a and 31b extend over only one or several portions of the length (along the longitudinal axis X) of the rotor 3.

According to an exemplary embodiment, the stator 2 may have an external diameter of 40.7 mm, an internal diameter of 21.8 mm and a length of 15 mm. The rotor 3 may have a diameter of 21.2 mm and a length of 20 mm. Preferably, the lengths of iron Lfer and air gap are set to Lfer=15 mm and e=0.3 mm, corresponding to the conventional dimensions in electromechanical actuator applications for actuating blinds or roller shutters. Under these conditions, the parameters Rb1, Rb2, Rfer and Lb of the rotor can take the values listed in the following table 1:

TABLE 1

| LB (mm) | Rbb (mm) | Rba (mm) | Rfer (mm) |
|---|---|---|---|
| 0.5 to 1.5 | 7.8 to 10 | 6 to 8.2 | 7 to 8.6 |

These values are obtained with 715-turn windings of 0.15 mm diameter wire, and 0.5 mm thick plates 33, 34, a sinusoidal control being applied to the motor 1a, the average torque obtained on the shaft of the motor 1a being between 32 and 35 mN·m.
Torque performance can be improved by reducing the impact of magnetic shunts, in particular by reducing the thickness of the sheets 34.
Similarly, the presence of two recesses forming flux barriers per pole makes it possible to limit torque ripples compared to a structure with a single recess forming a flux barrier per pole.

However, acoustically, the motor 1a has a noise spectrum comprising a peak at around 2 kHz which is within the spectrum audible to the human ear. However, the predominance of a noise peak at this frequency proves to be annoying to the human ear, with a perception of a high-pitched noise.

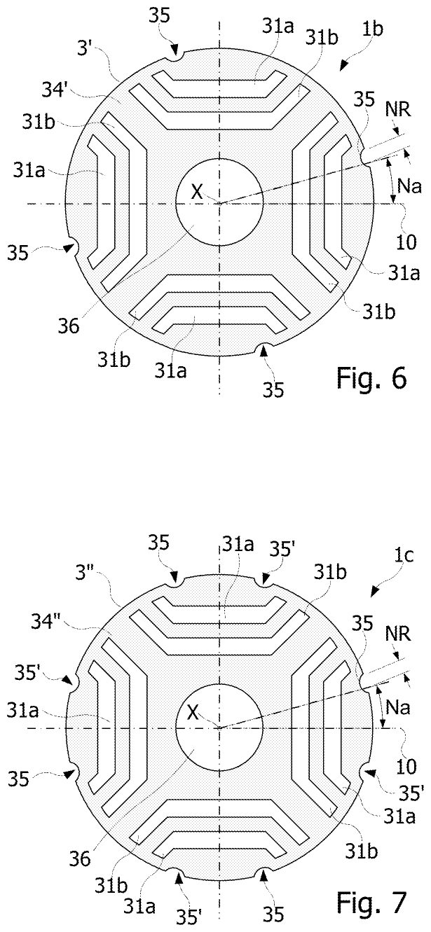

FIG. 6 represents a plate 34′ of a rotor 3′ of a motor 1b, according to one embodiment. The motor 1b differs from the motor 1a only by its rotor 3′. The rotor 3′ of the motor 1b differs from the rotor 3 in that the plates 33′, 34′ have notches 35 distributed on their edge. The notches 35 can be defined for example by their angular position Na and their radius NR. The angular position Na is defined with respect to a median plane 10 of the recesses 31a, 31b, including the longitudinal axis X of the rotor 3′. Once stacked and assembled, the notches 35 on the edge of the plates 33′, 34′ form grooves extending longitudinally along the rotor 3′.

According to one embodiment, the angular position Na of the notches 35 is between 0 and 35°, and the radius NR of the notches 35 is between 0.4 and 1.8 mm. When the notches 35 have an angular position Na of 20° and a radius NR of 0.7 mm, it can be observed that the audible noise peak is attenuated by 24 dBA, whether the motor 1b is at no load or under load, compared to the motor 1a without notches.

FIG. 7 illustrates a motor 1c according to another embodiment. The motor 1c differs from the motor 1b only by its rotor 3″. The rotor 3″ represented in FIG. 7 differs from the rotor 3′ in that the plates 33′, 34′ are replaced by plates 33″, 34″. The plates 33″, 34″ differ from the plates 33′, 34′ in that they each comprise a second notch 35′ arranged symmetrically to the notch 35 with respect to the median plane 10 of each of the recesses 31a, 31b. This arrangement does not significantly change the amplitude of the audible noise peak, but has the advantage of symmetrizing the behavior of the motor 1b according to both directions of rotation of the latter, in particular in terms of noise.

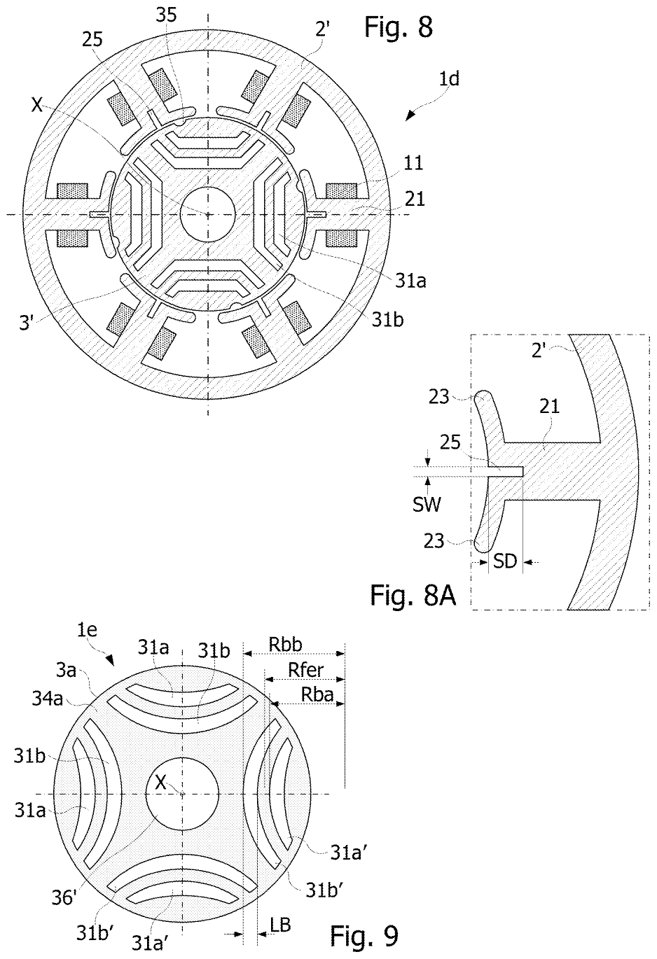

FIGS. 8, 8A illustrate a motor 1d according to another embodiment. The motor 1d is fitted with the rotor 3′ with the plates 33′, 34′ with one notch 35 per pole and a stator 2′. The stator 2′ differs from the stator 2 in that it comprises one notch 25 per tooth 21 in each plate forming the stator. Each tooth 21 of each plate forming the stator 2′ comprises one of the notches 25. Each notch 25 extends from the free end of one of the teeth 21 and is centered on the latter. Thus, the notches 25 form grooves extending longitudinally in the teeth 21 of the stator 2′. In FIG. 8A, each of the notches 25 is defined by its width SW and its depth SD in one of the teeth 21.

According to one embodiment, the notches 25 have a width SW of 0.2 to 3 mm and a depth SD of 0.2 to 6 mm.

By combining the notches 35 with an angular position Na of 25° and a radius NR of 1.25 mm, and the notches 25 with a width SW of 0.5 mm and a depth SD of 1 mm, the audible noise peak is attenuated by 15 dBA, whether the motor is at no load or under load, compared to the motor 1 without notches.

FIG. 11 represents an electromechanical actuator 50 according to one embodiment. The actuator 50 comprises a motor 56 which may be one of the previously described motors 1a, 1b, 41c, 1d, a speed reducer 57 coupled to an output shaft of the motor, and a control unit 55 connected to the motor 56, in particular to supply and drive the latter with electrical energy according to control commands. The speed reducer 57 comprises an output shaft 58 forming an output shaft of the actuator 50. The motor 56, the speed reducer 57, the output shaft 58 and the control unit 55 can be housed coaxially about an axis A in a cylinder-shaped casing 52 having an internal diameter corresponding to the external diameter of the stator of the motor 56. The speed reducer 57 can comprise an epicyclic type reducer and/or a mechanical or electromagnetic brake.

Thus, the actuator 50 can be disposed for example in a winding tube 60 of a blackout device such as a roller shutter or a blind. For this purpose, the output shaft 58 of the actuator 50 is coupled by a mechanical linkage 59 to the winding tube 60. Furthermore, a head 54 of the actuator 50 is fastened to a fixed structure 61. The actuator 50 also comprises a bearing crown 63 mounted on the casing 52 and free to rotate relative to the latter. The bearing crown 63 is rotatably fastened to the winding tube 60, so that the bearing crown 63 provides a rotating bearing function for the winding tube 60 on the casing 52 and/or on the head 54, on the control unit 55 side, the output shaft 58 providing on the other side the mechanical coupling between the actuator and the winding tube 60 via the mechanical linkage 59.

The electromechanical actuator 50 is supplied with electrical energy by a building's power supply network, for example by the AC mains network or by a direct current bus, or even by means of a battery, not shown, which can be recharged, for example, by a photovoltaic panel. Here, the electromechanical actuator 11 comprises a power supply cable 62 linked to a mains power supply network.

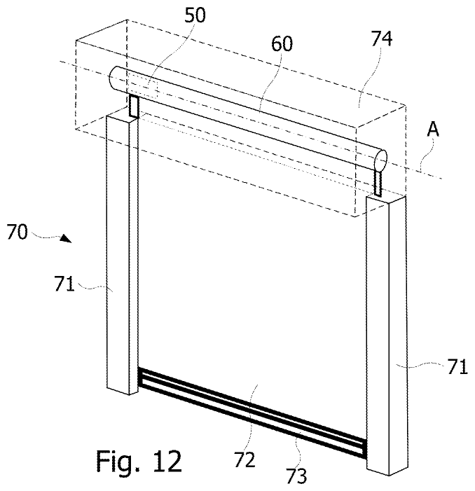

FIG. 12 represents a home automation installation according to one embodiment. The home automation installation can be installed in a building including an opening, window or door, fitted with a screen 72 belonging to a blackout device 70, in particular a motorized roller blind. The blackout device 70 can be alternatively a roller shutter, a blind with adjustable slats, or even a roller door. In practice, the present disclosure applies to all types of blackout device comprising a rotating motorized winding shaft.

The screen 72 of the blackout device 70 is wound on a winding tube such as the winding tube 60 driven by the electromechanical actuator 50. The screen 72 is movable between a wound position, in particular a high position, and an unwound position, in particular a low position.

In a known manner, the screen 72 of the blackout device 70 is formed by a canvas, which is attached by a first end to the winding tube and by the other end to a weighted bar 73. The high wound position of the screen corresponds to the position of the weighted bar at the winding tube 60 and the low unwound position corresponds to the position of the weighted bar 73 of the screen 72 at the sill of the opening. The deployment of the screen 72 can be guided by slides 71. The winding tube 60 can be disposed inside a cassette 74 or be visible. The winding tube 60 is movable in rotation relative to a support, such as a cheek, of the cassette 74.

It will be clear to those skilled in the art that the present disclosure is susceptible to various variants and various applications. In particular, the disclosure is not limited to actuators for shutters and blinds. It applies more generally to cylinder-shaped actuators having a power less than or equal to 300 W.

Furthermore, the number of magnetic poles of the rotor and the number of teeth of the stator can take other values, without departing from the scope of the present description. If the motor is controlled by three phases, it is simply important that the number of teeth of the stator is a multiple of 3.

The angles Na of the notches 35, 35′ are not necessarily identical from one plate 33′, 33″, 34′, 34″ to the other, so that the grooves formed by the notches 35, 35′ are not necessarily parallel to the axis X of the rotor, nor even rectilinear. In addition, not all plates 33′, 33″, 34′, 34″ are necessarily provided with notches 35 and/or 35′, so that the grooves on the rotor may be discontinuous or not extend along the entire length of the rotor. Thus, for example, only the plates 33′, 33″ could be provided with notches 35, 35′.

The grooves formed by the notches are not necessarily symmetrical with respect to median planes of the poles and passing through the longitudinal axis X of the rotor. Indeed, it may not be necessary to symmetrize the behavior of the motor in both directions of rotation, in particular in applications where the motor is only used in one direction of rotation.

The grooves 25 formed in the stator 2′ are not necessarily centered on the teeth 21. Indeed, an off-center position of the grooves 25 makes it possible to reduce the audible noise peak of the motor. In addition, the motor may comprise these stator grooves without grooves on the rotor. Indeed, such an arrangement also makes it possible to reduce the audible noise peak.

1. An electromechanical actuator for actuating a blackout device such as a roller shutter or a blind, comprising a casing, a head intended to be fastened to a fixed structure, a synchronous type motor, a speed reducer and a motor control unit, the motor, the speed reducer and the control unit being inserted into the casing of the electromechanical actuator, the motor comprising:
a cylinder-shaped rotor,
a cylinder-shaped stator, disposed coaxially about the rotor and including a plurality of teeth extending radially towards the rotor, and
a coil forming a winding about each of the teeth of the stator,
wherein:
the stator has an external diameter smaller than 55 mm,
the rotor is formed by an assembly of sheet metal plates,
the rotor comprises recesses about a longitudinal axis of the rotor, the rotor comprising an arrangement of the recesses forming four poles, the rotor comprising two or three recesses per pole formed about a longitudinal axis of the rotor and extending to a cylindrical face of the rotor.

2. The actuator according to claim 1, wherein the stator comprises six teeth.

3. The actuator according to claim 1, wherein the rotor comprises a first rotor groove extending on a cylindrical face of the rotor facing each of the poles, the first rotor groove being centered on a line located outside a first median plane of the pole passing through the longitudinal axis of the rotor.

4. The actuator according to claim 3, wherein the rotor comprises a second rotor groove extending on a cylindrical face of the rotor facing each of the poles.

5. The actuator according to claim 4, wherein the first and second rotor grooves are disposed symmetrically with respect to the first plane.

6. The actuator according to claim 4, wherein the first or second rotor groove or each of the first and second rotor grooves has at least one of the following characteristics:
an angular position about the longitudinal axis of the rotor with respect to the first plane, of between 0 and 35°,
a semi-circular section, and
a semi-circular section having a radius of between 0.4 and 1.8 mm.

7. The actuator according to claim 1, wherein each tooth of the stator comprises a stator groove formed in a free end of the tooth.

8. The actuator according to claim 7, wherein the stator groove formed in each tooth of the stator has at least one of the following characteristics:
it is centered in a second median plane of the tooth passing through a longitudinal axis of the stator,
it has a width of 0.2 to 3 mm, and
it has a depth of 0.2 to 6 mm.

9. The actuator according to claim 1, wherein the actuator is powered by the AC mains network.

10. The actuator according to claim 9, wherein the control unit applies a sinusoidal or trapezoidal control to the motor.

11. The actuator according to claim 1, wherein the stator is formed by an assembly of sheet metal plates.

12. The actuator according to claim 1, wherein the motor has a power less than or equal to 300 W.

13. The actuator according to claim 1, wherein the thickness of the sheets forming the rotor is between 0.3 and 0.7 mm.

14. A roller shutter or blind type blackout device, comprising an actuator according to claim 1.
